(19) United States
(12) Patent Application Publication
(10) Pub. No.: US 2007/0104111 A1
(43) Pub. Date: May 10, 2007

(54) Internal analog loopback for a high-speed interface test

(75) Inventor: Akira Kakizawa, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: INTEL CORPORATION

(21) Appl. No.: 11/267,436

(22) Filed: Nov. 4, 2005

(51) Int. Cl. H04J 3/14

(52) U.S. Cl. 370/249; 370/252

(57) ABSTRACT

Embodiments of the invention are generally directed to systems, methods, and apparatuses for an analog loopback for high-speed interface tests. In an embodiment, a chip includes a transmitter, a receiver, and a loopback circuit coupled between the transmitter and the receiver, wherein the loopback circuit is to provide an internal loopback path from the transmitter to the receiver. Other embodiments are described and claimed.

### TECHNICAL FIELD

Embodiments of the invention generally relate to the field of integrated circuits and, more particularly, to systems, methods and apparatuses for an internal loopback for high-speed interface tests.

### BACKGROUND

Computing systems typically include a number of integrated circuits that are connected by various interconnects (e.g., buses, links, etc.). For example, high-speed serial interconnects are frequently used to provide interconnections between chips and/or between a chip and an associated device. One example of a high-speed serial interconnect is an interconnect that complies, at least in part, with the PCI Express standard. The PCI Express standard refers to any of the PCI Express specifications including the specification entitled, “PCI Express 1.1,” promulgated by the PCI Special Interest Group (PCI SIG).

Integrated circuits use high-speed serial interfaces to connect with high-speed serial interconnects. These high-speed serial interfaces typically include an input/output (I/O) circuit. The design of these I/O circuits is typically complicated and, therefore, the manufacturing process may include a testing scheme to identify defects. For example, a conventional testing scheme can be used to test an I/O circuit.

The conventional testing scheme may include applying a test signal to the transmitter pads of an I/O circuit and looping the test signal back to the receiver pads of the I/O circuit. This scheme can be referred to as a loopback at the pads testing scheme because the test signal is routed (via a loop) from the transmitter pads to the receiver pads.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a high level block diagram illustrating selected aspects of a computing system having high-speed serial interfaces, implemented according to an embodiment of the invention.

FIG. 2 is a high level block diagram illustrating selected aspects of an input/output (I/O) circuit according to an embodiment of the invention.

FIG. 3 is a circuit diagram illustrating selected aspects of an I/O interface having an internal loopback circuit according to an embodiment of the invention.

FIG. 4 is a circuit diagram illustrating selected aspects of a differential comparator with a multiplexer, according to an embodiment of the invention.

FIG. 5 is a circuit diagram illustrating selected aspects of a differential comparator with a multiplexer according to an alternative embodiment of the invention.

FIG. 6 is a circuit diagram illustrating selected aspects of a differential comparator with a multiplexer according to another alternative embodiment of the invention.

FIG. 7 is a flow diagram illustrating selected aspects of a method of testing an I/O circuit according to an embodiment of the invention.

FIGS. 8A and 8B are block diagrams illustrating selected aspects of computing systems.

### DETAILED DESCRIPTION

Embodiments of the invention are generally directed to systems, methods, and apparatuses for an internal analog loopback for high-speed interface tests. An interface (e.g., a high-speed serial interface) may include an input/output (I/O) circuit having a transmitter and a receiver. In an embodiment, an internal loopback circuit is coupled between the transmitter and the receiver. As is further described below, the internal loopback circuit may be used to perform high-speed interface tests.

FIG. 1 is a high level block diagram illustrating selected aspects of a computing system having high-speed interfaces, implemented according to an embodiment of the invention. Computing system 100 includes chips 110 and 120 connected by interconnect 130. In an embodiment, chips 110 and 120 are part of the chipset for computing system 100. The chipset refers to a set of one or more integrated circuits (chips) that perform a number of functions (e.g., access to system memory, I/O, etc.) for computing system 100. For example, chip 110 may be a memory controller and chip 120 may be an input/output (I/O) controller.

Interconnect 130 may be either a serial interconnect or a parallel interconnect. In some embodiments, interconnect 130 is a high-speed serial interconnect. For example, in an embodiment, interconnect 130 is based, at least in part, on the PCI Express standard. In an alternative embodiment, interconnect 130 may be based (at least partly) on a different standard.

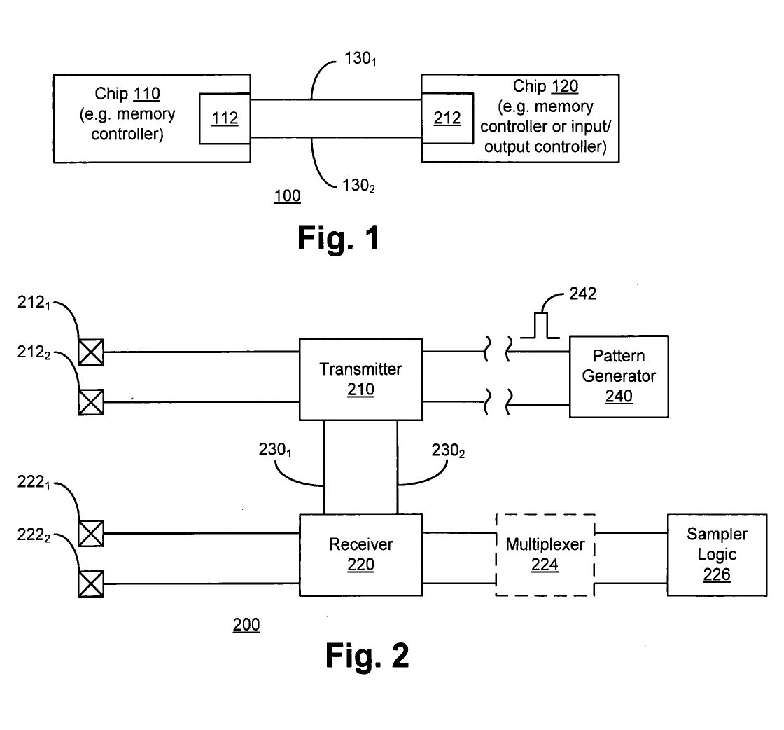

Chips 110 and 120 respectively include interfaces 112 and 212. Interfaces 112 and 212 may each include a transmitter, a receiver, and pads to connect with interconnect 130. In an embodiment, interfaces 112 and 212 further include an internal loopback circuit between the transmitter and the receiver that occurs before the pads. The term “loopback circuit” broadly refers to a connection between a transmitter and a receiver that can be used to loop signals from the transmitter to the receiver. As is further described below, in some embodiments, the loopback circuit enables interfaces 112 and 212 to be tested at high-speeds. Interfaces 112 and 212 are further discussed below with reference to FIGS. 2-8

FIG. 2 is a high level block diagram illustrating selected aspects of an input/output (I/O) circuit according to an embodiment of the invention. In an embodiment, I/O circuit 200 is part of a serial interface for a chip (e.g., interface 112 of chip 110).I/0 circuit 200 includes transmitter 210 and receiver 220. Transmitter 210 transmits data to an interconnect using pads 212. Similarly, receiver 220 receives data from an interconnect using pads 222. In the illustrated embodiment, I/0 circuit 200 is a differential circuit. That is, I/0 circuit 200 transmits and receives differential signals over pads 212 and 222, respectively.

In an embodiment, internal loopback circuit 230 is coupled between transmitter 210 and receiver 220. The term “internal” indicates, for example, that loopback circuit 230 is on the same die as I/0 circuit 200. In the illustrated embodiment, internal loopback circuit 230 includes two lines (e.g., 230₁ and 230₂) so that it can loop a differential signal to receiver 220.

In an embodiment, receiver 220 can selectively receive an input from either internal loopback circuit 230 or from pads 222. Typically, the input from internal loopback circuit 230 is selected when I/O circuit 100 is being tested. For example, in an embodiment, internal loopback circuit 230 is selected at wafer sort to provide testing of the die. The input from pads 222 may be selected during normal operation. The term “test signal” refers to a signal used to test aspects of I/O circuit 100. An “operation input” refers to a signal received during normal operation.

During a test, pattern generator 240 generates test signal 242. Test signal 242 may be, for example, any signal suitable for testing aspects of an interface. In an embodiment, test signal 242 is a signal suitable for testing a high-speed serial interface. For example, test signal 242 may have a frequency greater than 2.5 gigahertz. In an embodiment, test signal 242 has a frequency of approximately 5 gigahertz (plus or minus ten percent). In an alternative embodiment, test signal 242 may have different characteristics.

Transmitter 210 receives test signal 242 and transmits it to receiver 220 over internal loopback 230. Receiver 220, in turn, receives test signal 242 from internal loopback circuit 230. As is further discussed below, receiver 220 may be selectively coupled between internal loopback circuit 230 and pads 222 (using, for example, a multiplexer within receiver 220). In an embodiment, receiver 220 sends test signal 242 to sampler logic 226.

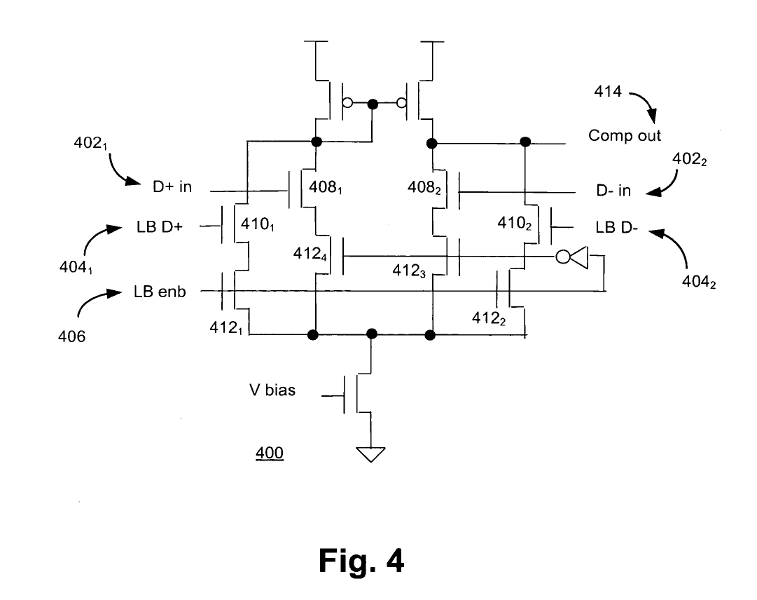

In some embodiments, receiver 220 includes a differential comparator with a multiplexer. In such embodiments, the differential comparator with a multiplexer selectively couples receiver 220 with either pads 222 or internal loopback circuit 230. In an alternative embodiment, multiplexer 224 may be used to select the appropriate input (e.g., either an operational input or a test signal). Examples of differential comparators having a multiplexer are discussed below with reference to FIGS. 4-6.

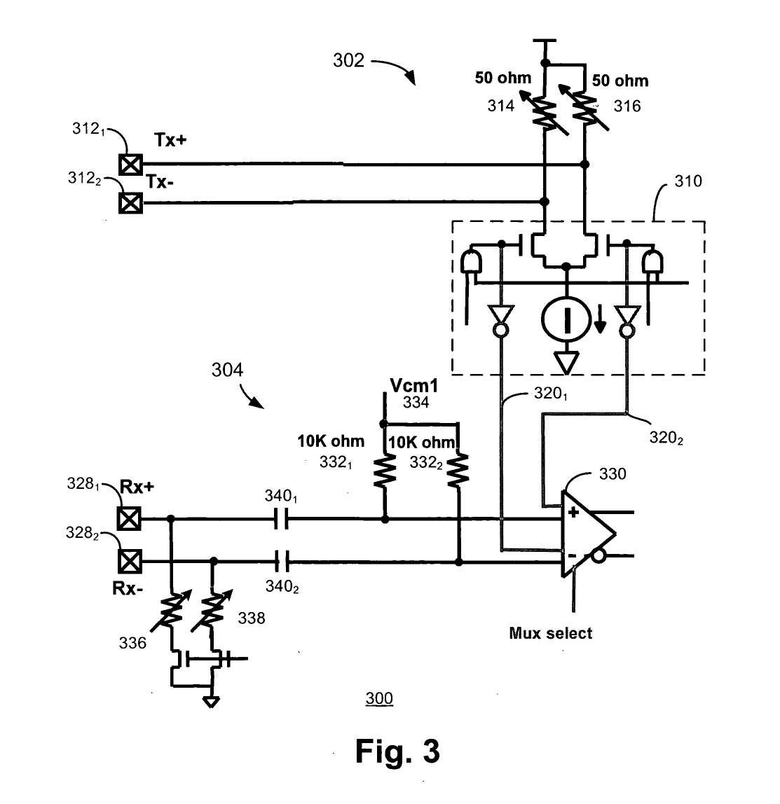

FIG. 3 is a circuit diagram illustrating selected aspects of an I/O circuit having an internal loopback circuit according to an embodiment of the invention. 1/0 circuit 300 includes transmitter 302 and receiver 304. I/O circuit 300 may be part of a serial interface or a parallel interface. In some embodiments, 1/0 interface 300 is part of a high-speed serial interface (e.g., a PCI Express interface).

Transmitter 302 includes positive transmitter pad 312₁, negative transmitter pad 312₂, pre-driver 310, and termination resistors 314 and 316. Pre-driver 310 is any of a wide-range of pre-drivers suitable for driving a final driver. Termination resistors 314 and 316 may be variable resistors. In one embodiment, termination resistors 314 and 316 each have a resistance of 50 ohms. In an alternative embodiment, transmitter 300 may include more elements, fewer elements, and/or different elements.

Receiver 304 includes positive receiver pad 328₁, negative receiver pad 328₂, capacitors 340, and resistors 332. Resistors 332₁, and 332₂ respectively couple common mode voltage supply 334 to pads 328₁, and 328₂. In one embodiment, resistors 332 each have a resistance of approximately 10K ohms. Capacitors 340 may each have capacitance of approximately 5 pF.

In an embodiment, I/O circuit 300 includes design for test (DFT) circuitry. The term DFT circuitry broadly refers to inserting test-specific features into a chip to enable the chip to be tested (e.g., during and/or after the manufacturing process). In the illustrated embodiment, the DFT circuitry includes loopback circuit 320. In an embodiment, loopback circuit 320 provides an internal path from transmitter 302 to receiver 304. This internal path may be used to test various aspects of I/O circuit 300. In an embodiment, the test can be run for a die at wafer sort and for a packaged units test at class. Thus, in an embodiment, internal loopback circuit 320 can be used to determine whether a failure is due to a socket related problem (external loopback fail) or due to a defect in the chip. This, in turn, can decrease manufacturing costs and improve the quality of manufactured chips.

In an embodiment, loopback circuit 320 supports the use of test signals that have higher frequencies than those that are used in conventional tests. One reason for this is that conventional tests (e.g., loopback at the pads) typically include a plurality of capacitors in the signal path between the transmitter pad and the receiver pad. These capacitors can degrade the performance of the signal going into the receiver.

In an embodiment, the DFT circuitry may also include a differential comparator with a multiplexer 330. Differential comparator with a multiplexer 330 may receive a differential input (e.g., either from pads 328 or from loopback circuit 320) and remove (at least in part) the common mode noise from the received signal. In addition, as the name implies, differential comparator with a multiplexer 330 may selectively couple receiver 304 to two or more inputs. For example, in one embodiment, differential comparator with a multiplexer 330 includes an analog multiplexer to select either an operational input (e.g., from pads 328) or a test input (e.g., from looback circuit 320). Differential comparator 330 is further discussed below with reference to FIGS. 4-6.

FIG. 4 is a circuit diagram illustrating selected aspects of a differential comparator with a multiplexer, according to an embodiment of the invention. Differential comparator with a multiplexer 400 (or, for ease of reference, comparator-multiplexer 400) is capable of selecting either an operational signal or a test signal as an input to a receiver (e.g., receiver 304, shown in FIG. 2). In an embodiment, comparator-multiplexer 400 enables either of these signals to be multiplexed directly into the receiver. In the illustrated embodiment, an operational input may be applied to inputs 402. Similarly, a test input may be applied to inputs 404. Inputs 402 are coupled with transistors 408 and output 414. In an embodiment, comparator-multiplexer 400 also includes inputs 404 coupled to receive a test signal from a loopback circuit (e.g. from loopback circuit 320, shown in FIG. 3). Inputs 404 are coupled with, for example, transistors 410 and output 414.

In an embodiment, LB enb 406 selects the input to comparator-multiplexer 400. For example, LB enb 406 may be asserted to enable test input 404 and disable operational input 402. In the illustrated embodiment, LB enb 406 is coupled with transistors 412. In an alternative embodiment, LB enb 406 may be coupled with more elements, fewer elements, and/or different elements.

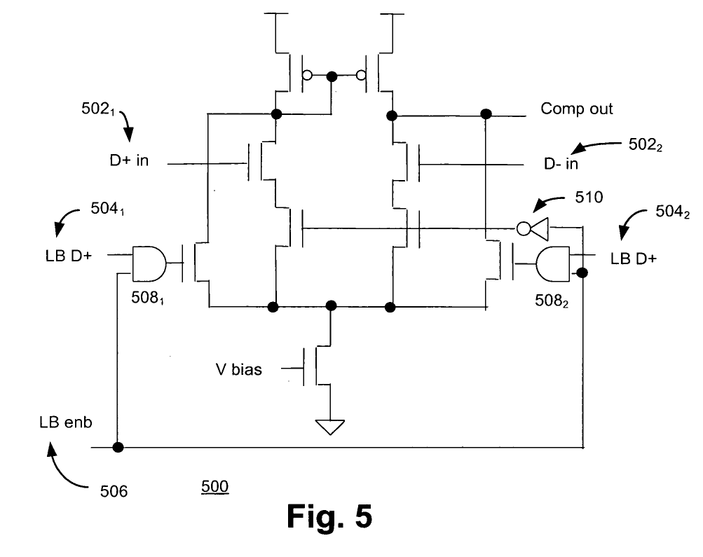

FIG. 5 is a circuit diagram illustrating selected aspects of a differential comparator with a multiplexer according to an alternative embodiment of the invention. In an embodiment, comparator-multiplexer 500 enables either an operational input (e.g., via inputs 502) or a test input (e.g., via inputs 504) to be directly multiplexed into a receiver. Comparator-multiplexer 500 includes AND gates 508₁, and 508₂. In an embodiment, AND gates 508₁ and 508₂ are respectively coupled with test inputs 504₁, and 504₂ as well as LB enb 506. In one embodiment, comparator-multiplexer 500 uses fewer transistors than, for example, comparator-multiplexer 400 because AND gates 508 are used in the signal pathway for LB enb 506.

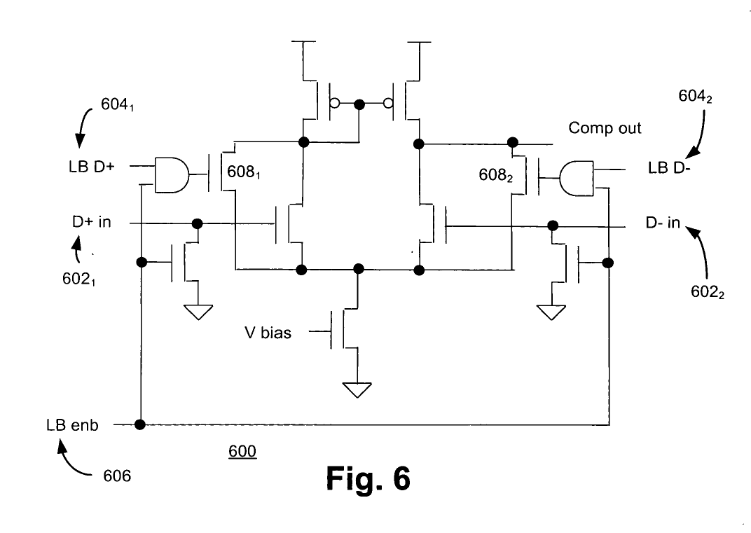

FIG. 6 is a circuit diagram illustrating selected aspects of a differential comparator with a multiplexer according to another alternative embodiment of the invention. In an embodiment, comparator-multiplexer 600 enables either an operational input (e.g., via inputs 602) or a test input (e.g., via inputs 604) to be directly multiplexed into a receiver. In an embodiment, comparator-multiplexer 600 reduces the load placed on an operational amplifier (op amp) within the associated receiver. The term “reduces the load” refers to creating less of a load on the op amp than, for example, the embodiment shown in FIG. 4. One reason that comparator-multiplexer 600 places a reduced load on the op amp is that it uses a single transistor 608 for the test inputs 604. In an embodiment, the reduced load on the op amp allows the size of the op amp to be reduced. Thus, the die area used by the receiver can also be reduced.

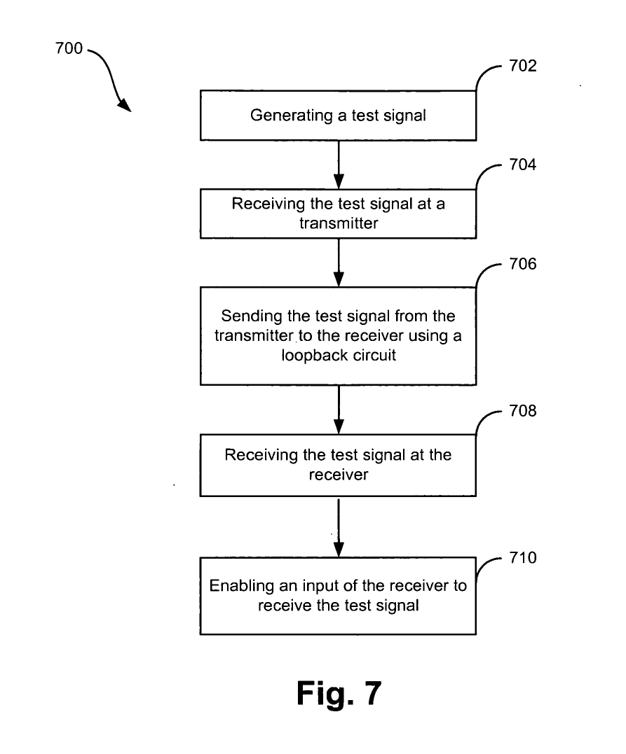

FIG. 7 is a flow diagram illustrating selected aspects of a method of testing an I/O circuit according to an embodiment of the invention. Referring to process block 702 a test signal is generated by, for example, a pattern generator. In an embodiment, the test signal is a high-speed signal having a frequency greater than 2.5 gigahertz. In one embodiment, the test signal may be any test signal suitable for testing a high-speed serial interface (e.g., a PCI Express interface).

Referring to process block 704, the test signal is received at a transmitter of an I/O circuit (e.g., transmitter 210, shown in FIG. 2). The transmitter may be, for example, the transmitter of a high-speed serial interface that is configured to receive a test signal from a source within (or external to) a chip. In an embodiment, the transmitter includes a transmitter pre-driver (e.g., transmitter pre-driver 310, shown in FIG. 3). In such embodiments, the test signal may be received by the transmitter pre-driver.

In an embodiment, the transmitter is coupled to an associated receiver via an internal loopback circuit. The term “internal loopback circuit” refers to a loopback circuit that occurs prior to the pads of the I/O circuit. In one embodiment, the loopback circuit provides a direct connection between the receiver and the transmitter. In an embodiment, the internal loopback signal imparts less distortion to a test signal than, for example, a loopback at the pads circuit because the internal loopback circuit provides a shorter signal path that includes fewer elements (e.g., fewer or no capacitors).

Referring to process block 706, the transmitter sends the test signal to its associated receiver using an internal loopback circuit (e.g., loopback circuit 320, shown in FIG. 3). In an embodiment, the transmitter includes a transmitter pre-driver and the test signal is sent from the transmitter pre-driver to the receiver over the internal loopback circuit. In one embodiment, the transmitter pre-driver sends a differential test signal to the receiver over the loopback circuit.

Referring to process block 708, the receiver receives the test signal from the loopback circuit. In an embodiment, the receiver includes a differential comparator with a multiplexer circuit (or simply, a comparator-multiplexer circuit). The comparator-multiplexer circuit may include inputs (e.g., differential inputs) for both an operational signal and a test signal. In an embodiment, the comparator-multiplexer multiplexes either the operational signal or the test signal directly into the receiver. In such an embodiment, receiving the test signal may include, receiving the test signal at the comparator-multiplexer circuit.

In an embodiment, the comparator-multiplexer includes an enable circuit to selectively enable (and/or disable) either the operational input or the test input. For example, in an embodiment, the comparator multiplexer is coupled to receive a test enable signal (e.g., LB enb 406, shown in FIG. 4). In addition, the comparator multiplexer may be configured (e.g., with an arrangement of transistors and/or AND gates) to selectively enable or disable the test signal inputs.

Referring to process block 710, an input (e.g., a differential input) of the receiver is enabled to receive the test signal. In an embodiment, “enabling the input” refers to enabling the test signal inputs of the comparator-multiplexer. In an alternative embodiment, a different input of the receiver may be enabled to receive the test signal.

Process blocks 702-710 need not be performed in the order shown in FIG. 7. That is, in some embodiments, process blocks 702-710 may be performed in an order different than the order shown in FIG. 7. Also, in some embodiments, process 700 may include more process blocks, fewer process blocks, and/or different process blocks. For example, in an embodiment, process 700 may include a process block directed to enabling a transmit loopback driver.

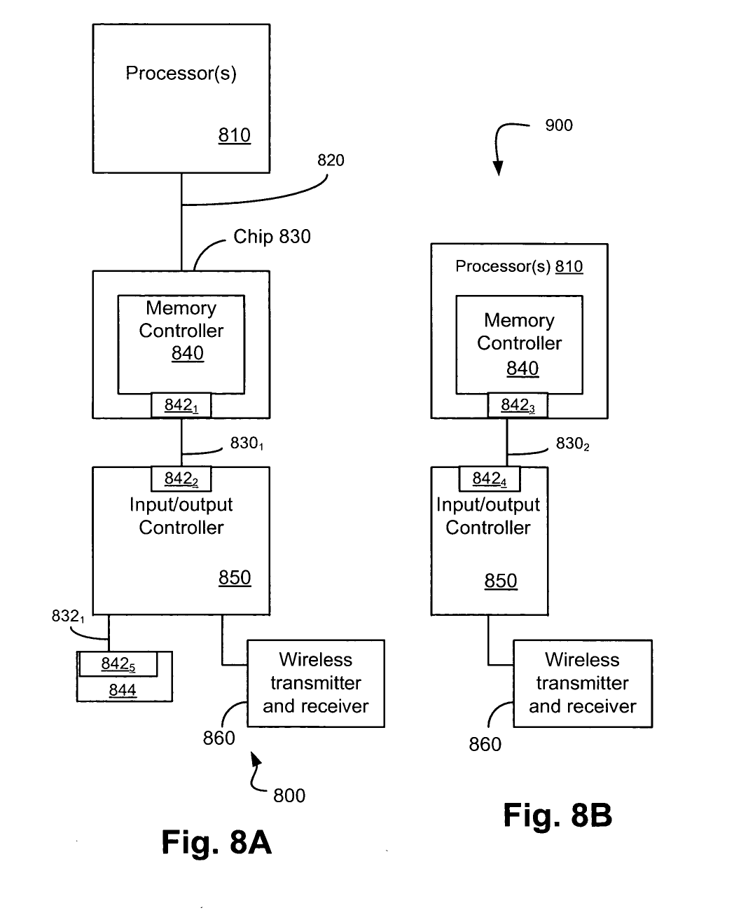

FIGS. 8A and 8B are block diagrams illustrating, respectively, selected aspects of computing systems 800 and 900. Computing system 800 includes processor 810 coupled with an interconnect 820. In some embodiments, the term processor and central processing unit (CPU) may be used interchangeably. In one embodiment, processor 810 is a processor in the XEON® family of processors available from Intel Corporation of Santa Clara, Calif. In an alternative embodiment, other processors may be used. In yet another alternative embodiment, processor 810 may include multiple processor cores.

In one embodiment, chip 830 is a component of a chipset. Interconnect 820 may be a point-to-point interconnect or it may be connected to two or more chips (e.g., of the chipset). Chip 830 includes memory controller 840 which may be coupled with main system memory (e.g., as shown in FIG. 1). In an alternative embodiment, memory controller 840 may be on the same chip as processor 810 as shown in FIG. 8B.

In an embodiment, high-speed serial interfaces 842 may provide interfaces between integrated circuits (e.g., chip 830, I/0 controller 850, etc.) and one or more interconnects (e.g., interconnect 830 and/or interconnect 832). High-speed serial interfaces 842 typically include a transmitter and a receiver. In an embodiment, a loopback circuit (e.g., loopback circuit 320, shown in FIG. 3) may provide a connection between the transmitters and receives of high-speed serial interfaces 842. In one embodiment, the loopback circuit may be used to when testing selected aspects of high-speed serial interface 842.

Input/output (I/O) controller 850 controls the flow of data between processor 810 and one or more I/0 interfaces (e.g., wired and wireless network interfaces) and/or I/0 devices. For example, in the illustrated embodiment, I/0 controller 850 controls the flow of data between processor 810 and wireless transmitter and receiver 860. In an alternative embodiment, memory controller 840 and I/O controller 850 may be integrated into a single controller.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

What is claimed is:

1. A chip comprising:
a transmitter to transmit data from the chip;
a receiver to receive data at the chip; and
a loopback circuit coupled between the transmitter and the receiver, wherein the loopback circuit is to provide an internal loopback path from the transmitter to the receiver.

2. The chip of claim 1, wherein
the transmitter comprises a transmitter pre-driver; and further wherein
the loopback circuit is coupled between the transmitter pre-driver and the receiver.

3. The chip of claim 2, wherein the receiver comprises a differential comparator multiplexer circuit.

4. The chip of claim 3, wherein the loopback circuit is coupled between the transmitter pre-driver and the differential comparator multiplexer circuit.

5. The chip of claim 3, wherein the differential comparator multiplexer circuit includes an input to receive a test signal from the loopback circuit.

6. The chip of claim 5, wherein the differential comparator multiplexer circuit is capable of selectively enabling and disabling an input from the loopback circuit.

7. The chip of claim 1, wherein the chip includes a memory controller.

8. The chip of claim 1, wherein the chip includes a input/output (I/O) controller.

9. The chip of claim 1, wherein the transmitter comprises a transmitter for a high-speed interface.

10. A method comprising:
sending a test signal from a transmitter of an integrated circuit to a receiver of the integrated circuit using a loopback circuit, wherein the loopback circuit is coupled between the transmitter and the receiver; and
receiving the test signal at the receiver of the integrated circuit.

11. The method of claim 10, wherein sending the test signal from the transmitter to the receiver comprises:
sending the test signal from a transmitter pre-driver of the transmitter to the receiver.

12. The method of claim 11, wherein receiving the test signal at the receiver of the integrated circuit comprises:
receiving the test signal at a differential comparator multiplexer circuit, wherein the differential comparator multiplexer circuit is an element of the receiver.

13. The method of claim 12, further comprising:
enabling an input of the differential comparator multiplexer circuit to receive the test signal from the loopback circuit.

14. The method of claim 10, further comprising:
generating a test signal; and
receiving the test signal at the transmitter of the integrated circuit.

15. A system comprising:
a first chip including a transmitter to transmit data from the first chip, a receiver to receive data at the first chip, and a loopback circuit coupled between the transmitter and the receiver, wherein the loopback circuit is to provide an internal loopback path from the transmitter to the receiver; and
a second chip coupled with the first chip via a serial interconnect.

16. The system of claim 15, wherein the first chip including the transmitter comprises:
a first chip including a transmitter having a transmitter pre-driver; and further wherein
the loopback circuit is coupled between the transmitter pre-driver and the receiver.

17. The system of claim 16, wherein the first chip including the receiver comprises:
a first chip including a receiver having a differential comparator multiplexer circuit; and further wherein
the loopback circuit is coupled between the transmitter pre-driver and the differential comparator multiplexer circuit.

18. The system of claim 17, wherein the differential comparator multiplexer circuit is capable of selectively enabling and disabling an input from the loopback circuit.

19. The system of claim 15, wherein the first chip comprises a memory controller.

20. The system of claim 15, wherein the second chip comprises an input/output (I/O) controller.
